(19) United States
(12) Patent Application Publication
(10) Pub. No.: US 2016/0167581 A1
(43) Pub. Date: Jun. 16, 2016

(54) DRIVER INTERFACE FOR CAPTURING IMAGES USING AUTOMOTIVE IMAGE SENSORS

(71) Applicant: SEMICONDUCTOR COMPONENTS INDUSTRIES, LLC, Phoenix, AZ (US)

(72) Inventor: Jeffery Beck, Philomath, OR (US)

(73) Assignee: SEMICONDUCTOR COMPONENTS INDUSTRIES, LLC, Phoenix, AZ (US)

(21) Appl. No.: 14/568,988

(22) Filed: Dec. 12, 2014

(51) Int. Cl. B60R 1/00; H04N 5/232; H04N 7/18

(52) U.S. Cl. CPC B60R 1/00; H04N 7/183; H04N 5/23216; B60R 2300/10

(57) ABSTRACT

Vehicles may include imaging systems that capture images and use the images to perform driver assist functions associated with the vehicle. The imaging system may include a user interface that enables the user of the vehicle to store the images after they are used in driver assist functions. The imaging system may export the images to an external device connected to a port in the vehicle or wirelessly transmit the images to an external device in response to commands from the user of the vehicle. The imaging system may display the images on a display in response to commands from the user of the vehicle. The imaging system may include multiple image sensors positioned at various locations. The imaging system may save images from some or all of the image sensors in response to commands from the user of the vehicle.

### BACKGROUND

This relates generally to imaging devices and, more particularly, to imaging devices that are used in vehicle safety systems.

Modern technology has seen an increased implementation of imaging systems in mobile devices. Mobile devices such as cellular telephones, PDAs, and computers are increasingly made to include imaging systems such as cameras so that a user of the mobile device can conveniently take photographs of their surroundings. Mobile devices with cameras appeal to users because they can conveniently take photographs regardless of the user's location. Mobile devices with cameras often present a distraction hazard to the user of the device, which may become particularly dangerous when the user's attention needs to be focused elsewhere, such as when the user is driving a motor vehicle. Such mobile devices can become especially hazardous to motor vehicle drivers when the driver attempts to use the mobile device to capture a photograph while driving, as the user may have to dig through their purse or pockets to retrieve the mobile device and may have to take their eyes off the road to open a photography application running on the mobile device, to align the camera on the mobile device with a scene to be imaged, and to capture the photograph. Such distractions caused by using the mobile device for capturing a photograph may put the user, pedestrians, and other drivers on the road at an increased risk of experiencing a traffic accident.

It would therefore be desirable to be able to provide improved systems and methods for allowing drivers to capture images while operating a vehicle.

### BRIEF DESCRIPTION OF THE DRAWINGS

FIG. 1 is a diagram of an illustrative system that includes an imaging system and a host subsystem in accordance with an embodiment of the present invention.

FIG. 2 is a diagram of an illustrative automotive imaging system having a user interface for capturing image data using the automotive imaging system in accordance with an embodiment of the present invention.

FIG. 3 is a flowchart of illustrative steps that may be performed by an automotive imaging system to capture image data based on user input in accordance with an embodiment of the present invention.

FIG. 4 is a diagram of an illustrative user interface having input/output devices for allowing a user to interface with and capture images from an automotive imaging system in accordance with an embodiment of the present invention.

FIG. 5 is a block diagram of a system employing the embodiments of FIGS. 1-4 in accordance with an embodiment of the present invention.

### DETAILED DESCRIPTION

Imaging systems having digital camera modules are widely used in electronic devices such as digital cameras, computers, cellular telephones, and other electronic devices. A digital camera module may include one or more image sensors that gather incoming light to capture an image.

In some situations, imaging systems having image sensors may form a portion of a larger system such as a surveillance system or a safety system for a vehicle (e.g., an automobile such as a car, truck, sports utility vehicle, or bus, an airplane, bicycle, motorcycle, boat, dirigible, or any other motorized or un-motorized vehicle). In a vehicle safety system, images captured by the imaging system may be used by the vehicle safety system to determine environmental conditions surrounding the vehicle. As examples, vehicle safety systems may include systems such as a parking assistance system, an automatic or semi-automatic cruise control system, an auto-braking system, a collision avoidance system, a lane keeping system (sometimes referred to as a lane drift avoidance system), etc. In at least some instances, an imaging system may form part of a semi-autonomous or autonomous self-driving vehicle. Such imaging systems may capture images and detect nearby vehicles, objects, or hazards using those images. If a nearby vehicle is detected in an image, the vehicle safety system may, if desired, operate a warning light, a warning alarm, or may activate braking, active steering, or other active collision avoidance measures. A vehicle safety system may use continuously captured images from an imaging system having a digital camera module to help avoid collisions with objects (e.g., other automobiles or other environmental objects), to help avoid unintended drifting (e.g., crossing lane markers) or to otherwise assist in the safe operation of a vehicle during any normal operation mode of the vehicle.

In some situations, the user of a vehicle (e.g., a driver) may wish to capture a photograph of their surroundings while operating the vehicle. Many users of a vehicle may possess a mobile device (e.g., a cell phone) having a camera for capturing images. However, use of such mobile devices to capture images while driving may pose a distraction hazard to the user while the user is driving. It may therefore be desirable to provide improved systems and methods for enabling a user to capture images while driving. If desired, a user interface may be provided that allows a user of a vehicle (e.g., a driver) to access images captured by the vehicle safety systems on a vehicle (e.g., images captured using image sensors that are involved in operating vehicle safety systems on the vehicle).

The vehicle safety system may include computing equipment (e.g., implemented on storage and processing circuitry having volatile or non-volatile memory and a processor such as a central processing system or other processing equipment) and corresponding drive control equipment that translates instructions generated by the computing equipment into mechanical operations associated with driving the vehicle. For example, the drive control equipment may actuate mechanical systems associated with the vehicle in response to control signals generated by the vehicle safety system. The vehicle safety system may process the image data to generate the control signals such that the control signals are used to instruct the drive control equipment to perform desired mechanical operations associated with driving the vehicle. For example, the drive control system may adjust the steering wheels of the vehicle so that the vehicle turns in a desired direction (e.g., for performing a parking assist function in which the vehicle is guided by the vehicle safety system into a parking spot, for performing lane assist functions in which the steering wheel is automatically adjusted to maintain the vehicle's course between road lane markers), may control the engine (motor) of the vehicle so that the vehicle has a certain speed or so that the vehicle moves forwards or in reverse with a desired engine power (e.g., the drive control system may adjust a throttle of the vehicle so that the vehicle maintains a desired distance with respect to another vehicle in front of the vehicle, etc.), may adjust braking systems associated with the vehicle (e.g., may actuate a parking brake, anti-lock brakes, etc.), or may perform any other mechanical operation associated with movement of the vehicle. The vehicle safety system may perform hazard detection operations that detect objects to the side of, in front of, and/or behind the vehicle that warn the driver of the hazard (e.g., via an alarm or display) and/or that automatically adjust the movement of the vehicle (e.g., by controlling the drive system) to avoid the detected hazard or object. Functions performed by the vehicle safety system for maintaining the safety of the vehicle (e.g., by controlling the drive control system) may sometimes be referred to herein as vehicle safety operations or vehicle safety functions.

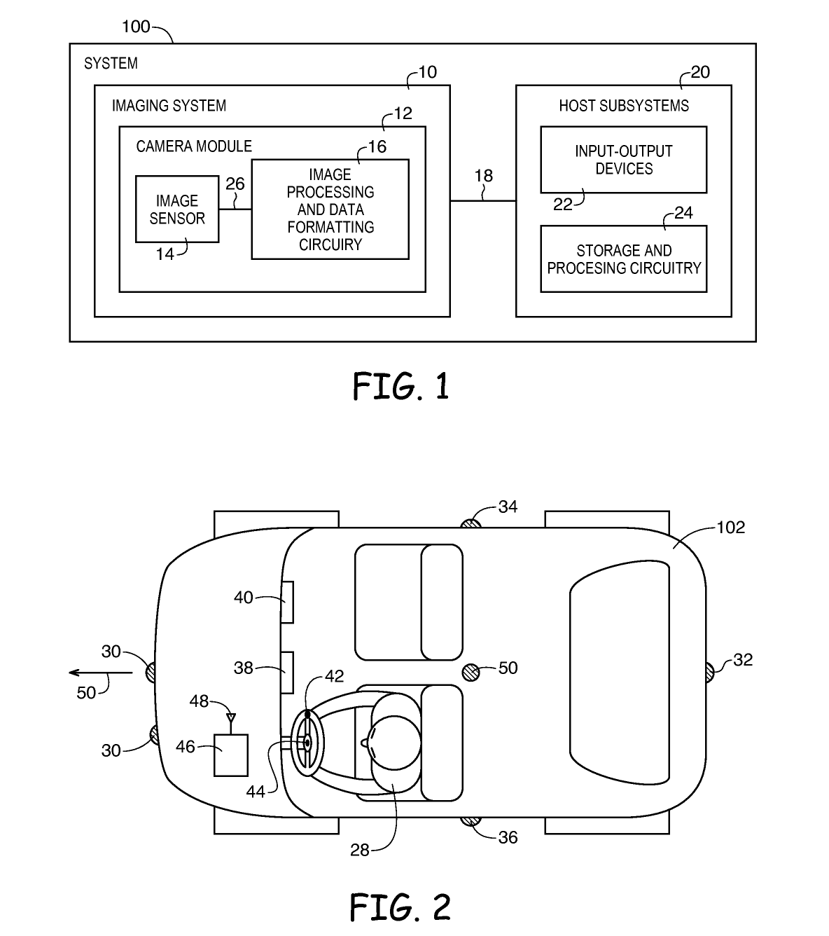

FIG. 1 is a diagram of an illustrative imaging and user interface system that uses an image sensor to capture images. System 100 of FIG. 1 may be a vehicle such as an automobile, a bus, a motorcycle, a bicycle, or any other vehicle. As shown in FIG. 1, system 100 may include an imaging system such as imaging system 10 and host subsystems such as host subsystem 20. Imaging system 10 may include camera module 12. Camera module 12 may include one or more image sensors 14 and one or more lenses (not shown for the sake of clarity).

Each image sensor in camera module 12 may be identical or there may be different types of image sensors in a given image sensor array integrated circuit. Each image sensor may be a Video Graphics Array (VGA) sensor with a resolution of 480×640 image sensor pixels (as an example). Other arrangements of image sensor pixels may also be used for the image sensors if desired. For example, images sensors with greater than VGA resolution (e.g., high-definition image sensors), less than VGA resolution and/or image sensor arrays in which the image sensors are not all identical may be used. During image capture operations, each lens may focus light onto an associated image sensor 14. Image sensor 14 may include photosensitive elements (e.g., pixels) that convert the light into digital data. Image sensors may have any number of pixels (e.g., hundreds, thousands, millions, or more). A typical image sensor may, for example, have millions of pixels (e.g., megapixels). Image sensor 14 may include, for example, bias circuitry (e.g., source follower load circuits), sample and hold circuitry, correlated double sampling (CDS) circuitry, amplifier circuitry, analog-to-digital (ADC) converter circuitry, data output circuitry, memory (e.g., buffer circuitry), address circuitry, or any other desired circuitry for capturing image data (e.g., a sequence of frames of image data). Image sensor 14 may capture still image frames and/or a series of video frames.

Still and video image data captured by image sensor 14 may be provided to image processing and data formatting circuitry 16 via path 26. Image processing and data formatting circuitry 16 may be used to perform image processing functions such as data formatting, adjusting white balance and exposure, implementing video image stabilization, face detection, etc. Image processing and data formatting circuitry 16 may also be used to compress raw camera image files if desired (e.g., to Joint Photographic Experts Group or JPEG format).

Imaging system 10 (e.g., image processing and data formatting circuitry 16) may convey acquired image data to host subsystem 20 over path 18. Host subsystem 20 may include computing equipment, processing circuitry, or any other desired equipment for processing data received from imaging system 10. Host subsystem 20 may include a vehicle safety system such as a surveillance system, parking assistance system, automatic or semi-automatic cruise control system, an auto-braking system, a collision avoidance system, or a lane keeping system. Host subsystem 20 may include processing circuitry and/or corresponding software running on the processing circuitry for detecting objects in images, detecting motion of objects between image frames, determining distances to objects in images, filtering or otherwise processing images provided by imaging system 10. Host subsystem 20 may include a warning system configured to disable imaging system 10 and/or generate a warning (e.g., a warning light on an automobile dashboard, an audible warning or other warning) in the event that verification image data associated with an image sensor indicates that the image sensor is not functioning properly. If desired, host subsystem 20 may include control circuitry that controls one or more automotive systems implemented on system 100. For example, host subsystem 20 may provide control signals to automated steering equipment to perform lane adjustment or cruise control operations (e.g., to maintain a desired distance form a car in front of system 100 based on image data captured by image sensor 14, etc.).

If desired, system 100 may provide a user with one or more high-level functionalities. For example, a user may be provided with the ability to run user applications on host subsystem 20. To implement these functions, host subsystem 20 of system 100 may include input-output devices 22. Input-output devices 22 may be used to allow data to be supplied to system 100 (e.g., by the user) and to allow data to be provided from system 100 to external devices (e.g., from imaging system 10 to the user). Input-output devices 22 may include user interface devices, data port devices, and other input-output components. For example, input-output devices 22 may include touch screens, displays without touch sensor capabilities, displays with touch sensor capabilities, buttons, joysticks, touch pads, toggle switches, dome switches, key pads, keyboards, microphones, cameras, speakers, status indicators, light sources, audio jacks and other audio port components, digital data port devices, light sensors, motion sensors (accelerometers), capacitance sensors, proximity sensors, or any other desired devices for providing data and/or control signals from system 100 to a user or corresponding user equipment and/or from the user to system 100.

Storage and processing circuitry 24 may include volatile and nonvolatile memory (e.g., random-access memory, flash memory, hard drives, solid state drives, etc.). Storage and processing circuitry 24 may also include microprocessors, microcontrollers, digital signal processors, application specific integrated circuits, etc. Storage and processing circuitry 24 may store data captured by imaging system 10 and may store and process commands received from a user via input-output devices 22. If desired, host subsystems may include wireless communications circuitry for communicating wirelessly with external equipment (e.g., a radio-frequency base station, a wireless access point, and/or a user device such as a cellular telephone, Wi-Fi® device, Bluetooth® device, etc.). Wireless communications circuitry on host subsystems 20 may include circuitry that implements one or more wireless communications protocols (e.g., Wi-Fi® protocol, Bluetooth® protocol, etc.) for communicating with external devices.

During operation of system 100, the user of the system may use input-output devices 22 to send a command to host subsystem 20 to store image data on storage and processing circuitry 24. Based on the user input command, host subsystem 20 may direct storage and processing circuitry 24 to store a single image frame capture. Alternatively, host subsystem may direct storage and processing circuitry 24 to continuously store a sequence of image frame captures as a video. Host subsystem 20 could direct storage and processing circuitry 24 to intermittently store a single image frame capture. For example, storage and processing circuitry 24 could store 1 out of every 10 image frame captures, 1 out of every 1,000 image frame captures, 1 out of every 100,000 image frame captures, or any other suitable interval.

Based on a user input command using input-output devices 22, host subsystem 20 may direct input-output devices 22 to display, send, or otherwise save stored image data. For example, host subsystem 20 could use input-output devices 22 to display a capture image or a video on a touch screen or a display without touch sensor capabilities. Host subsystem 20 could direct storage and processing circuitry 24 to store captured image data on volatile or nonvolatile memory. Alternatively, host subsystem 20 could direct storage and processing circuitry 24 to use wireless communications circuitry to wirelessly send captured image data to an external device. For example the user could provide a user input command that caused storage and processing circuitry 24 to wirelessly send captured image data to the user's mobile device or personal computer.

FIG. 2 is an illustrative diagram of imaging and vehicle safety system 100 implemented on an automobile 102. This example is merely illustrative and, if desired, system 100 may be formed on any other desired vehicle. As shown in FIG. 2, automobile 102 is oriented in direction 50 while a user (driver) 28 operates automobile 102. The automobile may include one or more cameras for use in a vehicle safety system. In the example of FIG. 2, cameras formed on automobile 102 include forward facing cameras such as cameras 30, rear facing cameras such as camera 32, right-side facing cameras such as camera 34, left-side facing cameras such as camera 36, top facing cameras such as camera 50, and interior (e.g., driver) facing cameras such as camera 44. Cameras 30, 32, 34, 36, 44, and 50 may be formed on the interior and/or exterior of automobile 102. Cameras 30, 32, 34, 36, 44, and 50 may face the interior and/or exterior of automobile 102. For example, cameras 30, 32, 34, 36, and 50 may be formed on the exterior of automobile 102 and face the exterior of automobile 102, as shown in FIG. 2. Alternatively, cameras 30, 32, 34, 36, and 50 may be formed on the interior of automobile 102 and face the exterior of automobile 102. Camera 44 may be formed on the interior of automobile 102. The example of FIG. 2 is merely illustrative and not meant to be limiting in any way, as there may be any number of cameras at any desired location in or on automobile 102. Any combination of cameras in vehicle 102 may be used as a part of host subsystems 20 for a vehicle safety system. For example, a single camera, two cameras, more than two cameras, or every camera may be used as part of a vehicle safety system.

Automobile 102 may include input output devices 22 for receiving an input from driver 28. For example, automobile 102 may include button 42. Driver 28 may input user commands to host subsystem 20 using button 42. For example, user 28 may press button 42 to instruct imaging system 10 to capture and/or store an image or video onto storage and processing circuitry 24. Imaging system 10, storage and processing circuitry 24, and input output devices 22 may be located in the interior and/or exterior of automobile 102. Imaging system 10 may capture and store an image from a single camera on automobile 102, may capture and store an image from a subset of cameras on automobile 102 simultaneously, or may capture and store an image from all of the cameras on automobile 102 simultaneously when button 42 is pressed.

If desired, user 28 may connect user equipment to system 100 for storing images captured by system 100. For example, user 28 may attach an external device to port 40 of system 100 (E.g., port 40 may form a part of input/output devices 22 of FIG. 1). After an image is captured, the image may be stored on the external device located in port 40. Port 40 may, for example, include universal serial bus (USB) circuitry for interfacing with an external USB storage device, optical drive hardware for interfacing with an optical disc, memory card interface circuitry for interfacing with an external memory card such as a Secure Digital (SD) memory card or an xD-picture memory card, hard drive interface circuitry for interfacing with an external hard drive or solid state drive, etc. In general, any external device that can be used for storing digital data can be used to access the captured images via port 40. Port 40 may also be used to load the captured image data to a mobile electronic device such as a cellular telephone or mobile computer (e.g., a cellular telephone connected to port 40 via a USB cable, etc.). The user may remove the external device with the captured image data if desired. User 28 may input a command via button 42 that causes the captured image data to be stored on an external device that was located in port 40 (e.g., the same button 42 used to capture the image data may be used to store the captured data on the external storage device or different buttons may be used to capture the image data and store the image data on the external storage device).

If desired, after an image is captured, the image data may be transmitted using wireless transceiver circuitry 46. Wireless transceiver circuitry 46 may transmit the captured image data via antenna 48 to wirelessly send the captured image data to an external electronic device such as a mobile phone belonging to user 28, a wireless access point or base station, or any other external wireless communications equipment. As one example, wireless transceiver circuitry 46 may transmit the captured image data to a mobile telephone belonging to user 28 via Wi-Fi® (IEEE 802.11) communications bands at 2.4 GHz and 5.0 GHz (also sometimes referred to as wireless local area network or WLAN bands) and/or the Bluetooth® band at 2.4 GHz. As another example, wireless transceiver circuitry 46 may transmit the captured image data using a cellular telephone standard communications protocol such as a Long-Term-Evolution (LTE) protocol or 3G Universal Mobile Telecommunications System (UTMS) protocol, Global System for Mobile Communications (GSM) protocol, etc. User 28 may input a command via button 42 that causes the captured image data to be wirelessly transmitted to an external device (e.g., the same button 42 used to capture the image data may be used to wirelessly transmit the captured data or different buttons may be used to capture the image data and wirelessly transmit the captured image data to the external storage device).

If desired, when driver 28 presses button 42, the captured image data may be displayed onto display equipment such as display 38 (e.g., a display that forms a part of input-output devices 22 of FIG. 1). As one example, when user 28 presses button 42, the cameras on system 100 may capture an image and display the captured image on display 38. User 28 may provide additional input (e.g., via button 42, via a touch screen interface on display 38, etc.) instructing system 100 to store the image displayed on screen 38. In yet another example, screen 38 may continuously display images captured using the cameras in system 100, user 28 may inspect the images shown on display 38, and when user 38 sees an image on display 38 that the user wishes to save, user 28 may press button 42 to store or transmit the image being displayed on display 38. In one suitable arrangement, display 38 may only display captured images or video while vehicle 102 is stationary or in “park,” thereby ensuring the safety of the driver.

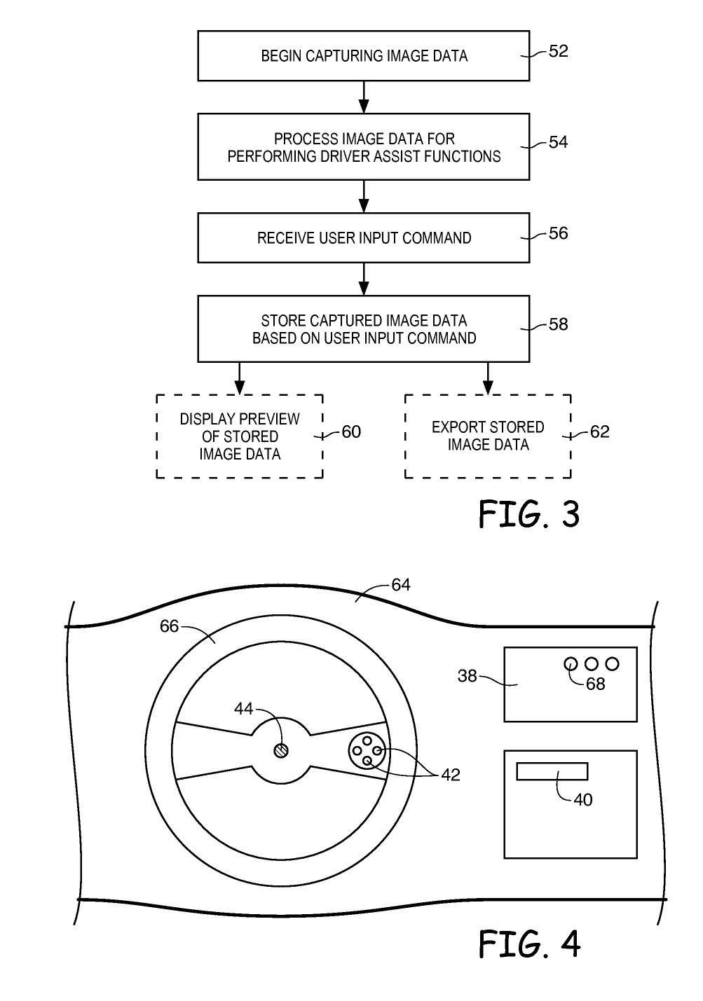

FIG. 3 is a flowchart showing illustrative steps that may be performed by system 100 to capture image data based on user input (e.g., while the user is driving a corresponding vehicle such as vehicle 102 of FIG. 2).

At step 52, an imaging system such as imaging system 10 may begin capturing image data using at least one camera. Any suitable number of cameras may be used to capture image data, and the cameras may be located at any suitable location on the vehicle. For example, there may be one or more cameras located on the front of the vehicle, one or more cameras located on the right side of the vehicle, one or more cameras located on the left side of the vehicle, one or more cameras located on the rear of the vehicle, and/or one or more cameras located on the top of the vehicle.

The image data captured in step 52 may be captured at any suitable frame rate. For example, the aforementioned cameras could capture image data with 10 frames per second, 60 frames per second, 74 frames per second, 1000 frames per second, or any other suitable number of frames per second.

At step 54, image processing and data formatting circuitry such as image processing and data formatting circuitry 16 may be used in conjunction with a host subsystem such as host subsystem 20 to perform driver assist functions (e.g., vehicle safety system functions). For example, the image data may be processed for use in a surveillance system, parking assistance system, automatic or semi-automatic cruise control system, an auto-braking system, a collision avoidance system, a lane keeping system, etc. The captured image data may be used to perform driver assist and/or vehicle safety system functions without storing the image data on external storage circuitry (e.g., via port 40) or on external wireless communications circuitry (e.g., via antenna 48).

At step 56, imaging system 100 may receive a user input command delivered to a host subsystem such as host subsystem 20 using an input-output device such as input-output device 22. The input-output device may be a button such as button 42 shown in FIG. 2.

At step 58, storage and processing circuitry such as storage and processing circuitry 24 store the captured image data (e.g., on external storage circuitry) based on the user input command received at step 56. After receiving the user input command, the captured input data that is being used to perform driver assist functions may be saved (e.g., for possible access at a later time by the user). Depending on the received user command, the storage and processing circuitry may save a single frame from each camera being used for the driver assist functions, a single frame from a subset of the cameras being used for the driver assist functions, a video from each camera being used for the driver assist functions, or a video from a subset of the cameras being used for the driver assist functions. Alternatively, depending on the received user command, the storage and processing circuitry may intermittently save a single frame from each camera being used in the driver assist functions or a single frame from a subset of the cameras being used for the driver assist functions. For example, the storage and processing circuitry may save a single frame every second, a single frame every minute, a single frame every five minutes, or a single frame per any other amount of time.

If desired, the user input command at step 56 may instruct system 100 to selectively store either a still image or video data. For example, user 28 may press a button 42 that instructs system 100 to store a video file from the captured image data. As another example, a single button 42 may be used to store both video data and still image frames. If desired, button 42 may be held down by user 28 for the duration of the video (e.g., user 28 may press button 42 to begin capturing video and may hold down button 42 for the desired duration of the video capture). In general, any desired user inputs may be received and processed for capturing and storing image data.

At optional step 60, a host subsystem such as host subsystem 20 may use the user input command received at step 56 to display a preview of the image data stored in step 58. The image could be displayed on a touch screen or a display without touch sensor capabilities. The image could be displayed on a liquid crystal display (LCD), a light emitting diode (LED) display, an organic light emitting diode (OLED) display, a plasma display, or any other type of display. In one embodiment of the present invention, step 60 would be limited to only occur when the vehicle 102 is in park to ensure the safety of the driver of the vehicle. An additional user input command could be used to direct the host subsystem to display the preview of the image.

At optional step 62, host subsystem 20 may use the user input command received in step 56 or an additional user input command to export the image data stored at step 58. The image data may, if desired, be exported using wireless transceiver circuitry such as wireless transceiver circuitry 46 and/or to an external device located in a port such as port 40. In scenarios where display 38 shows a preview of the image data (E.g., at step 60), user 28 may provide additional input (e.g., via touch screen commands on display 38 or buttons 42) to instruct the device to save the image/video data previewed on screen 38 to a device in port 40 and/or to an external wireless device via transceiver 46.

An example of one possible arrangement for the input-output devices of system 100 is shown in FIG. 4. As shown in FIG. 4, input-output devices such as buttons 42 may be located on steering wheel 66. There may be any suitable number of buttons within accessible reach of driver 28. For example, there may be a single button that captures image data from every camera in system 100 at the same time. In another example, there may be multiple buttons, each corresponding to a unique camera in system 100 (e.g., so that that button captures and/or stores image data from a corresponding camera). There may be a first button corresponding to a front facing camera, a second button corresponding to a rear facing camera, a third button corresponding to a right-side facing camera, a fourth button corresponding to a left-side facing camera, a fifth button corresponding to a top facing camera, and a sixth button corresponding to a driver facing button, for example. In yet another example, there may be a single button used to toggle between a plurality of cameras and select a single camera with which to capture an image. The term “button” is not meant to be limiting in any way and can be taken to mean any type of input-output device such as touch screens, displays without touch sensor capabilities, buttons, joysticks, touch pads, key pads, keyboards, microphones, cameras, buttons, speakers, status indicators, light sources, audio jacks and other audio port components, digital data port devices, light sensors, motion sensors (accelerometers), capacitance sensors, proximity sensors, etc. Additionally, the aforementioned examples specifying the number of buttons and their corresponding cameras are not meant to be limiting in any way. Any suitable number of buttons, with each button being connected to any camera or any set of cameras may be used without deviating from the scope of the present invention.

Display 38 may be located on dashboard 64 of the vehicle. Alternatively, the display may be located at any other suitable location such as the steering wheel or behind the steering wheel. Display 38 may be a touch screen display or a display without touch sensor capabilities. The display could be a liquid crystal display (LCD), a light emitting diode (LED) display, an organic light emitting diode (OLED) display, a plasma display, or any other type of display. Display 38 may be equipped with additional buttons 68 (e.g., graphical buttons displayed on display 38 or dedicated hardware buttons around the periphery of display 38). Buttons 68 may be used to preview images as described in step 60 of FIG. 3 or to export images shown on display 38 to external storage devices (e.g., as described in step 62 of FIG. 3).

If desired, a driver facing camera 44 may be located on steering wheel 68 and may face user 28. Alternatively, driver facing camera 44 may be located on dashboard 64 or any other location that is suitable for capturing images of the driver 28 (e.g., so-called “self-portrait” images). Port 40 may be located on dashboard 64 of the vehicle, on steering wheel 66, or at any other desired location on the vehicle.

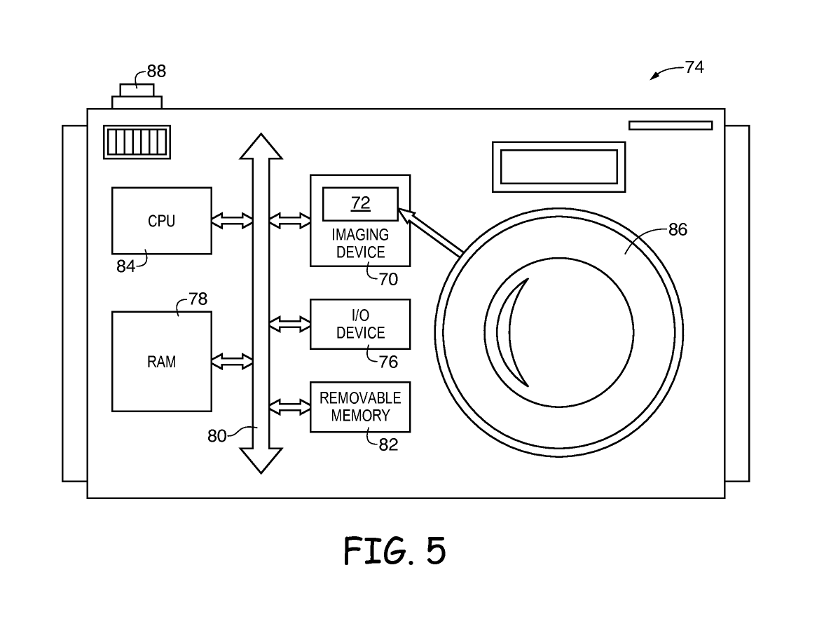

FIG. 5 shows in simplified form a typical processor system 74 which includes an imaging device 70. Imaging device 70 may include a pixel array 72 formed on an image sensor 14. Processor system 74 is exemplary of a system having digital circuits that may be included in system 100. Without being limiting, such processor system 74 may include a computer system, still or video camera system, scanner, machine vision, vehicle navigation, video phone, surveillance system, auto focus system, star tracker system, motion detection system, image stabilization system, and other systems employing an imaging device.

Processor system 74, which may be a digital still or video camera system, may include a lens such as lens 86 for focusing an image onto a pixel array such as pixel array 72 when shutter release button 88 is pressed. Processor system 74 may include a central processing unit such as central processing unit (CPU) 84. CPU 84 may be a microprocessor that controls camera functions and one or more image flow functions and communicates with one or more input/output (I/O) devices 76 such as buttons 42 and display 38 over a bus such as bus 80. Imaging device 70 may also communicate with CPU 84 over bus 80. System 74 may include random access memory (RAM) 78 and removable memory 82. Removable memory 82 may include flash memory that communicates with CPU 84 over bus 80. Removable memory 82 may be stored on an external device that is connected to a port such as port 40. Although bus 80 is illustrated as a single bus, it may be one or more buses or bridges or other communication paths used to interconnect the system components.

Various embodiments have been described illustrating a method of operating an imaging system on a vehicle that is formed with at least one image sensor, processing circuitry, a user input device, and memory circuitry. The at least one image sensor may be used to capture image data that is used by the processing circuitry to perform a driver assist function associated with the vehicle such as a parking assistance function, a cruise control function, an auto-braking function, a collision avoidance function, or a lane keeping function. The user input device may be used to obtain a user input command that results in the processing circuitry storing the captured image data.

In response to the user input command, the processing circuitry may store any amount of captured image data. For example, the processing circuitry may store a single frame of image data, a single frame of image data each time a predetermined time interval passes, or a continuous series of frames of image data (e.g., a video). Based on the particular user input command, the processing circuitry may continuously capture image frames until an additional user input command is received.

The processing circuitry may store captured image data from any number of image sensors positioned in or on the vehicle. Image sensors may face the exterior of the vehicle on any or all sides of the vehicle. The image sensor may store captured image data from any or all sides of the vehicle based on the particular user input command provided to the user input device.

The imaging system may optionally export the stored image data to an external device that is separate from the memory circuitry. For example, the stored image data may be exported to an external device connected to a universal serial bus port. In addition to or instead of this export, the stored image data may be wirelessly transmitted to an external device using wireless communications circuitry.

The user input device may be part of a user interface that also includes a display. The display may display the captured image data in response to an additional user input command to the user input device. The display may optionally be configured to only display images when the vehicle is not in motion to ensure safety of the user of the vehicle.

The foregoing is merely illustrative of the principles of this invention which can be practiced in other embodiments.

What is claimed is:

1. A method of operating an imaging system formed on a vehicle, wherein the imaging system comprises at least one image sensor, processing circuitry, a user input device, and memory circuitry, the method comprising:
with the at least one image sensor, capturing image data;
with the processing circuitry, performing a driver assist function associated with the vehicle based on the captured image data;
with the user input device, obtaining a user input command; and
with the processing circuitry, storing the captured image data on the memory circuitry in response to obtaining the user input command.

2. The method defined in claim 1, further comprising:
after storing the captured image data on the memory circuitry, exporting the stored image data to an external device that is separate from the memory circuitry.

3. The method defined in claim 2, wherein the imaging system further comprises wireless communications circuitry and wherein exporting the stored image data to the external device comprises:
wirelessly transmitting the stored image data from the memory circuitry to the external device using the wireless communications circuitry.

4. The method defined in claim 1, wherein storing the captured image data comprises saving a single frame of the captured image data to the memory circuitry.

5. The method defined in claim 4 further comprising:
with the user interface, obtaining an additional user input command after saving the single frame of image data to the memory circuitry; and
exporting the saved single frame of image data to an external device that is separate from the memory circuitry in response to the additional user input command.

6. The method defined in claim 4, wherein the imaging system further comprises a display located on one of a dashboard and a steering wheel of the vehicle, the method further comprising:
with the user interface, receiving an additional user input command after saving the single frame of image data to the memory circuitry; and
displaying the single frame of image data on the display in response to the additional user input command.

7. The method defined in claim 6, further comprising:
determining whether the vehicle is in motion; and
in response to determining that the vehicle is not in motion, displaying the single frame of image data on the display in response to the additional user input command.

8. The method defined in claim 1, further comprising:
with the user input device, continuously receiving the user input command; and
storing the captured image data on the memory circuitry while the user input command is received.

9. The method defined in claim 8, wherein obtaining the user input comprises:
with the user interface, identifying a button press operation performed by a user of the vehicle.

10. The method defined in claim 1, wherein performing the driver assist function comprises performing a driver assist function selected from the group consisting of: a parking assistance function, a cruise control function, an auto-braking function, a collision avoidance function, and a lane keeping function.

11. An imaging system, comprising:
processing circuitry;
an image sensor that captures image data;
a vehicle safety system that performs vehicle safety operations for a vehicle based on the image data captured by the image sensor; and
a user input device, wherein the processing circuitry is configured to save the image data captured by the image sensor based on a user input command received by the user input device.

12. The imaging system defined in claim 11, wherein the vehicle comprises a steering wheel and wherein the user input device comprises at least one button located on the steering wheel.

13. The imaging system defined in claim 11, further comprising:
an additional image sensor; and
an additional user input device, wherein the processing circuitry is configured to save the image data captured by the image sensor in response to the user input command received by the user input device and wherein the processing circuitry is configured to save the image data captured by the additional image sensor in response to an additional user input command received by the additional user input device.

14. The imaging system defined in claim 11, further comprising:
a display, wherein the display is configured to display the saved image data in response to an additional user input command received by the user input device.

15. The imaging system defined in claim 11, further comprising:
at least one universal serial bus port that receives a corresponding external storage device, wherein the processing circuitry is configured to transfer the saved image data to the external storage device in response to the user input command.

16. The imaging system defined in claim 15, wherein the at least one universal serial bus port is located on a dashboard of the vehicle.

17. The imaging system defined in claim 11, wherein the vehicle has first and second opposing sides and third and fourth opposing sides that are substantially perpendicular to the first and second opposing sides, wherein the image sensor comprises a first image sensor formed on the first side of the vehicle, the imaging system further comprising:
a second image sensor formed on the second side of the vehicle, wherein the processing circuitry is configured to save image data captured by the first and second image sensors in response to receiving the user input command.

18. The imaging system defined in claim 17, further comprising:
a third image sensor formed on the third side of the vehicle; and
a fourth image sensor formed on the fourth side of the vehicle, wherein the processing circuitry is configured to save image data captured by the third and fourth image sensors in response to receiving the user input command.

19. The imaging system defined in claim 11, further comprising:
at least one additional image sensor, wherein the processing circuitry is configured to save the image data captured by the at least one additional image sensor based on a user input command received by the user input device and the at least one additional image sensor is oriented to face a driver of the vehicle.

20. A system, comprising:
a central processing unit in a vehicle having an interior and an exterior;
memory;
input-output circuitry mounted to the interior of the vehicle;
a driver assist system that performs driver assist functions for the vehicle;
an imaging device mounted to the vehicle and oriented to face the exterior of the vehicle;
a lens that focuses image light onto the imaging device, wherein the imaging device captures image data that is used by the driver assist system for performing the driver assist functions for the vehicle and wherein the central processing unit is configured to save the captured image data to the memory in response to detecting a user input event using the input-output circuitry; and
a display mounted to a dashboard of the vehicle, wherein the display is configured to display the image data in response to detecting the user input event using the input-output circuitry.
